(19) United States
(12) Patent Application Publication
(10) Pub. No.: US 2009/0290190 A1
(43) Pub. Date: Nov. 26, 2009

(54) Priority Order Determination Method and Priority Order Determination Program for Print Job, and Printing System

(76) Inventor: Yuko Torii, Atsugi-shi (JP)

Correspondence Address: Cameron Kerrigan;Squire, Sanders & Dempsey L.L.P., Suite 300, One Maritime Plaza, San Francisco, CA, 94111, US

(21) Appl. No.: 12/405,922

(22) Filed: Mar. 17, 2009

(30) Foreign Application Priority Data
May 21, 2008 (JP) JP2008-132950

(51) Int. Cl. G06F 3/12

(52) U.S. Cl. 358/1.15

(57) ABSTRACT

A priority order determination method for print jobs in a printing system which can execute normal print jobs by submitting the print jobs and confidential print jobs by logging-in after submission of the confidential print job, the method includes: prioritizing a second print job relating to confidential printing over a first print job relating to normal print job, in a case when login for the second print job is requested during printing of the first print job and the second print job has been submitted before the first print job.

### RELATED APPLICATION

This application is based on Japanese Patent Application No.2008-132950 filed on May 21, 2008 in Japan Patent Office, the entire content of which is hereby incorporated by reference.

### BACKGROUND OF THE INVENTION

The present invention relates to methods and programs for determining priority order, and printing systems. More particularly, the present invention relates to a priority order determination method and a priority order determination program for determining the priority order of a plurality of print jobs, and a printing system which allows processing of both confidential and normal printings.

Printing devices such as printers and digital complex machines (hereinafter referred to as image forming apparatuses) have gained in popularity and have been widely used in companies. A variety of documents are printed on such image forming apparatuses, including a document that any user can access to (referred to as a normal document) and a document that contains confidential information which only certain users can access to (referred to as a confidential document). Thus, when confidential documents are to be printed, the printing must be controlled not to leak any confidential information.

A system for printing confidential documents is provided with a client's computer terminal, an image forming apparatus, a security management device, and an authentication server on a network, and it controls confidential printing in such a way that, when a print job is sent from the client, the security management device asks the user to input user information and authenticates the user by checking with the authentication server, and upon successful user authentication, the print job is sent to the image forming apparatus to print the confidential document.

The above control method can assure security; however, it is inconvenient for confidential printing users because, since the confidential printing user must input his/her user information to the security management device and then wait for the print output at the image forming apparatus, when, for example, there is a print job currently executed, which is referred as “current print job”, or printing jobs in print queue, the user must keep waiting for the completion of his/her printing at the image forming apparatus. To solve this problem, a method is proposed which allows confidential printing to interrupt by priority.

For example, Unexamined Japanese Patent Publication No. 2003-33065 discloses an interrupt processing method which allows a confidential print job to be printed first over a current print job that is not a confidential print but is a sort job, by stopping the current print job for a moment at its break of a copy.

In addition, Unexamined Japanese Patent Publication No. 2006-1127 discloses a technology which registers an interrupting job in the order after a current print job, provided that the current print job is a type of job which requires authentication prior to printing and the interrupting job is submitted during the printing of the current print job, to print the interrupting job after the completion of the current print job.

Furthermore, Unexamined Japanese Patent Publication No. 2006-59338 discloses a technology which executes a print interruption process under the condition when a print job received is a confidential print job, another print job is being processed, and a plurality of paper ejection outlets are available.

Aforementioned unexamined Japanese Patent Publication Nos. 2003-33065, 2006-1127, and 2006-59338 are all about a method for prioritizing confidential printing, thus the confidential printing can be efficiently processed. However, the normal print job submitted first is interrupted by the confidential print job submitted later, which hinders the normal printing user from completing his/her printing by the time estimated at the print job submitted. In addition, if confidential printing is unlimitedly allowed to interrupt, it will become impossible to estimate a completion time of normal printing.

In other words, although the methods of Unexamined Japanese Patent Publication Nos. 2003-33065, 2006-1127, and 2006-59338 can improve the convenience of confidential printing users, they significantly reduce the convenience of normal printing users, creating a problem of unfairness among users.

### SUMMARY

The present invention has one perspective addressing the above problem, and the major object of the present invention according to the perspective is to provide a priority order determination method and a priority order determination program for print jobs, and a printing system, which can redress the unfairness among users by efficiently processing both of the normal and confidential printing.

To achieve at least one of the abovementioned objects and the other objects, a priority order determination method reflecting first aspect of the present invention is a priority order determination method for print jobs in a printing system which can execute normal print jobs by submitting the print jobs and confidential print jobs by user's logging-in after submission of the confidential print job, the method comprising: prioritizing a second print job relating to confidential printing over a first print job relating to normal print job, in a case when login for the second print job is requested during printing of the first print job and the second print job has been submitted before the first print job.

According to the method reflecting second aspect of the present invention, the priority order determination method further comprising notifying that the second job can not be started when the first print job has been submitted before the second print job.

According to the method reflecting third aspect of the present invention, the priority order determination method further comprising notifying that the second print job is ready to start when the first print job has completed.

According to the method reflecting fourth aspect of the present invention, the priority order determination method further comprising calculating a completion time of each of a plurality of print jobs submitted in the system in accordance with the priority order of the plurality of print jobs, and notifying the calculated completion time.

### BRIEF DESCRIPTION OF THE DRAWINGS

FIG. 1 is a schematic diagram showing a configuration of the printing system concerning an embodiment of the present invention.

FIG. 2 is a block diagram showing a detailed configuration of the printing system concerning an embodiment of the present invention.

FIG. 3 is a diagram showing another configuration of the printing system concerning an embodiment of the present invention.

FIG. 4 is a diagram showing another configuration of the printing system concerning an embodiment of the present invention.

FIG. 5 is a flowchart showing the procedures of the priority order determination method for print jobs, concerning an embodiment of the present invention.

FIG. 6 shows an example of a screen (job list screen) displayed on a client, concerning an embodiment of the present invention.

FIG. 7 shows an example of a screen (job list screen) displayed on a security management device, concerning an embodiment of the present invention.

FIG. 8 shows an example of a screen (confidential printing unable-to-start notification screen) displayed on a security management device, concerning an embodiment of the present invention.

FIG. 9 shows an example of a screen (confidential printing ready-to-print notification screen) displayed on a client, concerning an embodiment of the present invention.

FIG. 10(a) is a flowchart showing specific procedures in the printing system concerning an embodiment of the present invention.

FIG. 10(b) is a flowchart showing specific procedures in the printing system concerning an embodiment of the present invention.

FIG. 10(c) is a flowchart showing specific procedures in the printing system concerning an embodiment of the present invention.

FIG. 10(d) is a flowchart showing specific procedures in the printing system concerning an embodiment of the present invention.

FIG. 11 is a flowchart showing specific procedures for a print start process in the printing system concerning an embodiment of the present invention.

FIG. 12 is a flowchart showing specific procedures for a current print-job interrupt process in the printing system concerning an embodiment of the present invention.

### DETAILED DESCRIPTION OF THE PREFERRED EMBODIMENTS

As shown in the background of the invention, in the environment for both the confidential and normal printings, the confidential printing is conventionally prioritized when there is an interruption by the confidential printing (login request). Because of this, normal print jobs are unlimitedly interrupted by confidential print jobs, which leads to a problem that the convenience of normal printing users is substantially reduced.

On the other hand, a confidential printing user is required not only to input his/her user information on the security management device after sending the print job from the client, but also to wait for the print output at the image forming apparatus; this leads to a problem that the convenience of the confidential printing users is substantially reduced if the normal printing and the confidential printing are treated equally.

Therefore, in the environment for both the confidential and normal printing, it is important to reduce the unfairness among confidential printing users and normal printing users.

Thus, in the present embodiment, the confidential printing is not simply prioritized but prioritized in consideration of the order of print job submitted. In this way, while improving the convenience of confidential printing users, the method can redress the unfairness to normal printing users whose print job has been submitted earlier but kept getting interrupted. The method in the present embodiment can also allow print completion times to be estimated.

### Embodiments

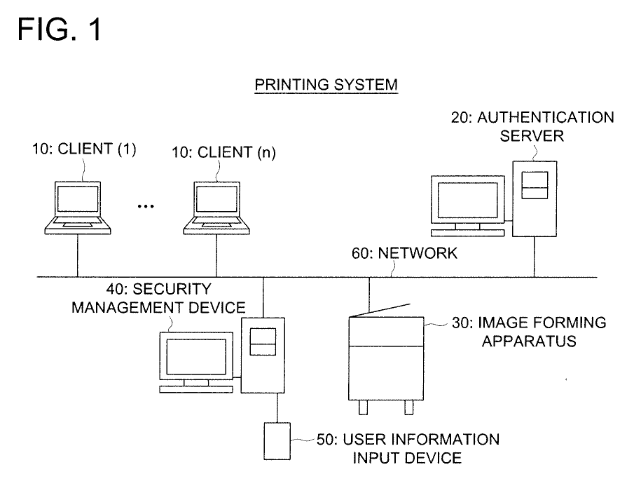

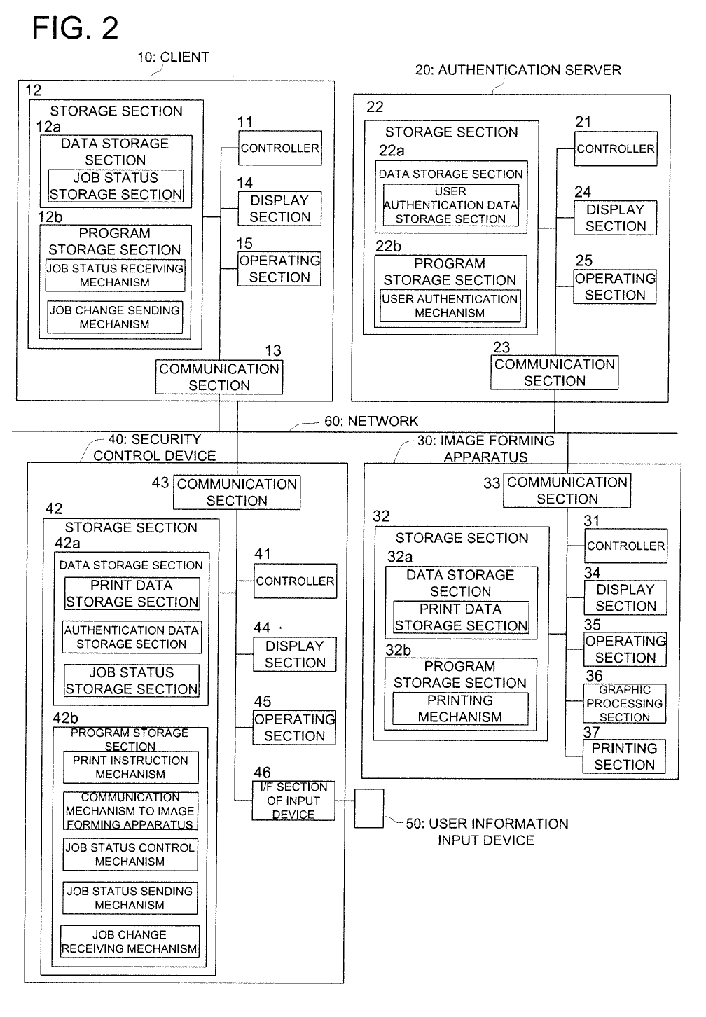

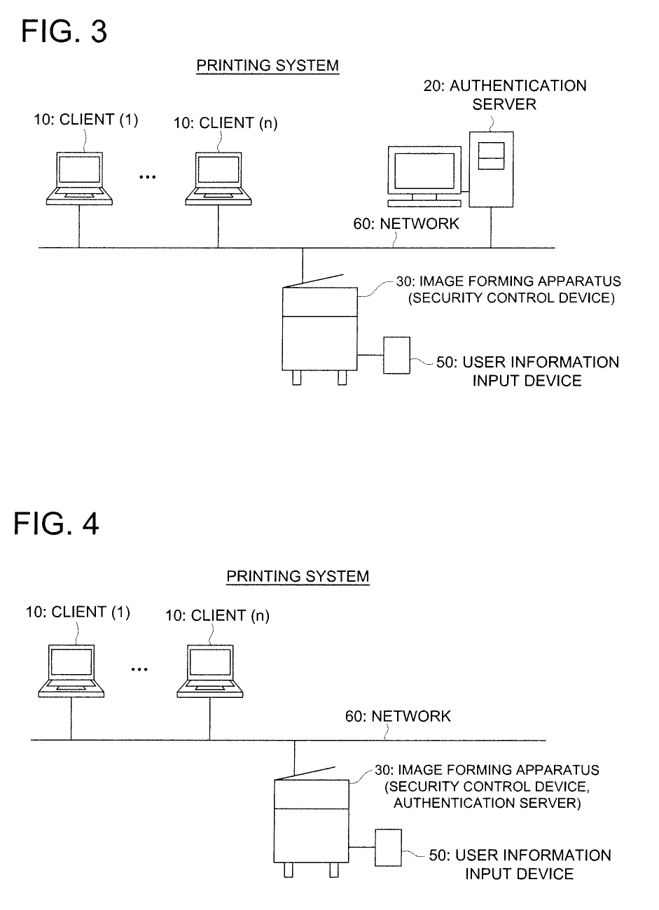

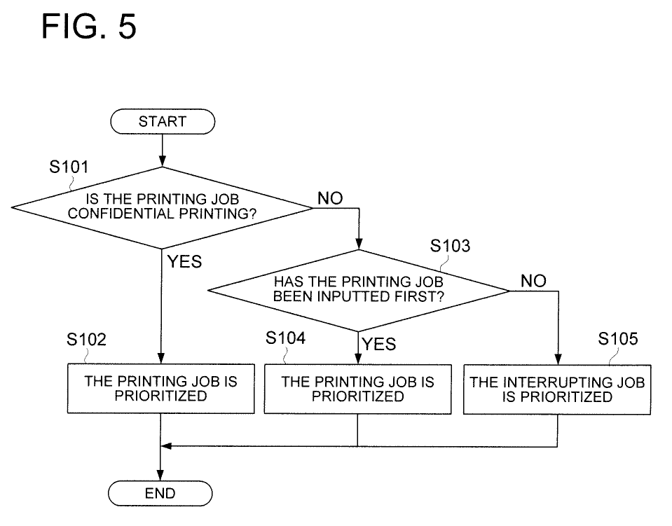

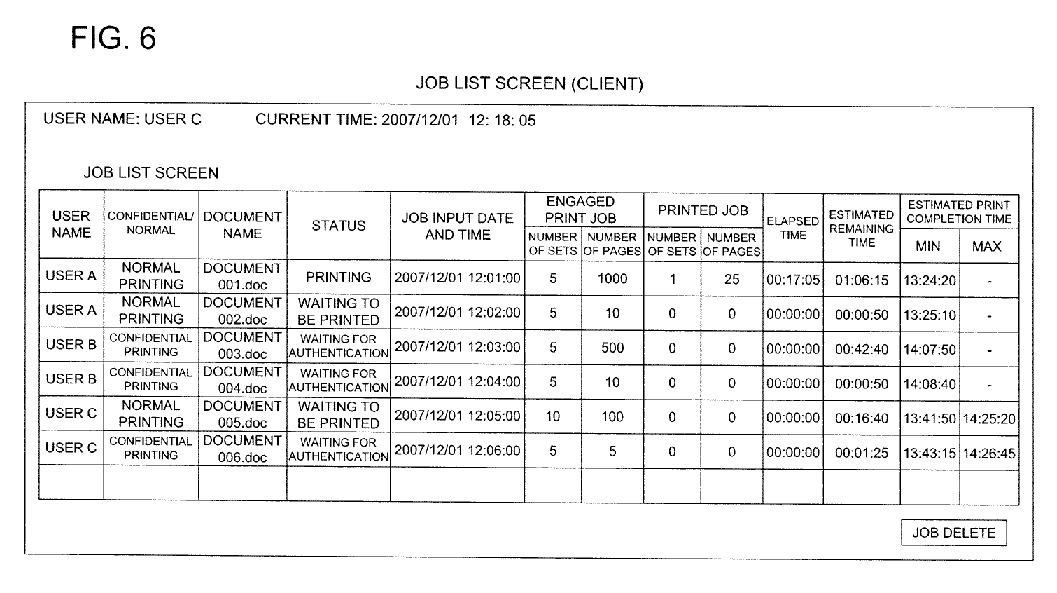

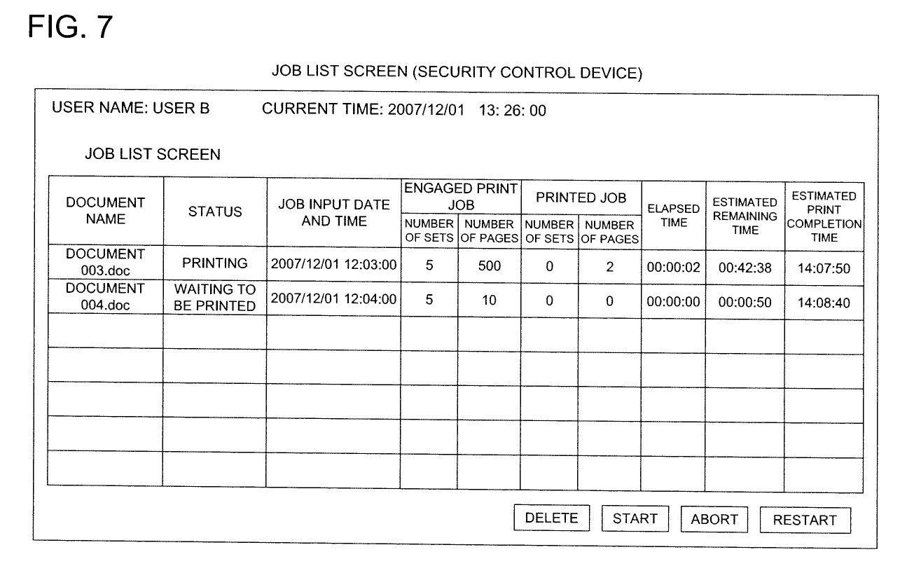

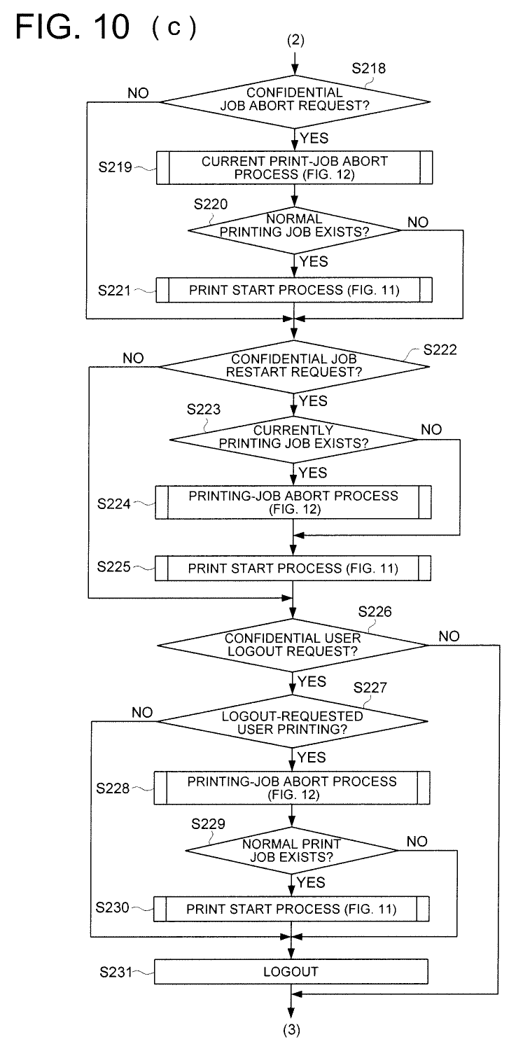

In order to explain in more detail about an embodiment of the above present invention, the priority order determination method and the priority order determination program for print jobs, and a printing system concerning the embodiment of the present invention are described with reference to FIGS. 1 to 12. FIG. 1 is a schematic diagram showing a configuration of the printing system in the present embodiment, and FIG. 2 is a block diagram showing a specific configuration of each device. FIGS. 3 and 4 show other configurations of the printing system in the present embodiment, and FIG. 5 is a flowchart showing the procedures to determine the priority order of print jobs in the present embodiment. FIGS. 6 to 9 show screen examples displayed by the printing system in the present embodiment, and FIGS. 10 to 12 are flowcharts showing specific procedures in the printing system in the present embodiment.

As shown in FIG. 1, the printing system in the present embodiment includes a client 10 which is a computer terminal of a user, an authentication server 20 such as an AD (Active Directory) or LDAP (Lightweight Directory Access Protocol), an image forming apparatus 30 such as a printer or a digital complex machine, and a security management device 40 for managing print jobs. They are connected via a network 60 such as a LAN (Local Area Network) or WAN (Wide Area Network). In addition, the security management device 40 connects to a user information input device 50 for reading user information stored in an IC card, and the like. The specific configuration of each device is described below with reference to FIG. 2.

[Client]

The client 10 comprises a controller 11, storage 12, communication section 13, display 14, and operation section 15.

The controller 11 comprises a CPU (Central Processing Unit) and so on. The storage 12 comprises a memory such as a ROM (Read Only Memory) and RAM (Random Access Memory), HDD (Hard Disk Drive), and so on; and has a data storage 12a for storing job status, etc., and a program storage 12b for storing programs such as a job status receiving mechanism for receiving job status from the security management device 40 and a job change sending mechanism for sending job changes to the security management device 40. The programs stored in the ROM and HDD are opened or loaded in the RAM and executed by the CPU. In the present embodiment, the controller 11 creates a print job including print data such as the data written in PDL (Page Description Language) such as PS (Post Script) and PCL (Printer Control Language), PDF (Portable Document Format) data, etc., and sends the print job to the security management device 40 or the image forming apparatus 30; the controller also functions as a printer driver for instructing normal or confidential printings.

The communication section 13 comprises a NIC (Network Interface Card), modem, etc., and allows communication with the image forming apparatus 30 and the security management device 40. The display 14 comprises an LCD (Liquid Crystal Display) and the like, to display a job list screen and a ready-to-print notification screen which are to be described later. The operating section 15 comprises a keyboard, mouse, etc., and allows a variety of operations such as print job creation.

[Authentication Server]

The authentication server 20 comprises a controller 21, storage 22, communication section 23, display 24, and operating section 25.

The controller 21 comprises a CPU and so on. The storage 22 comprises a memory such as a ROM and RAM, HDD, etc., and has a data storage 22a for storing user authentication data and so on, and a program storage 22b for storing a program performing a user authentication function and so on. The programs stored in the ROM and HDD are opened or loaded in the RAM and executed by the CPU. In the present embodiment, the controller 21, by executing the user authentication mechanism, can also function as a user authentication section for authenticating a user by comparing the user information sent from the security management device 40 and the user authentication data stored in the data storage 22a.

The communication section 23 comprises a NIC, modem, etc., and allows communication with the image forming apparatus 30 and security management device 40. The display 24 comprises an LCD, etc., and displays an authentication screen, etc. The operating section 23 comprises a keyboard, mouse, etc., and allows a variety of operations related to authentication.

[Image Forming Apparatus]

The image forming apparatus 30 comprises a controller 31, storage 32, communication section 33, display 34, operating section 35, graphic processing section 36, and printer 37.

The controller 31 comprises a CPU and so on. The storage 32 comprises a memory such as a ROM and RAM, HDD, etc., and has a data storage 32a for storing print data and so on, and a program storage 32b for storing a program performing a print function and so on. The programs stored in the ROM and HDD are opened or loaded in the RAM and executed by the CPU.

The communication section 33 comprises a NIC, modem, etc., and allows communication with the authentication server 20 and the security management device 40. The display 34 comprises an LCD, etc., and displays an operation screen, etc. The operation section 35 comprises a touch panel, etc., and allows a variety of operations for the image forming apparatus 30.

The graphic processing section 36 analyzes print data received from the client 10 and security management device 40, rasterizes the print data to create printable bitmap data, and if necessary, performs image processing such as color change, color density adjustment, etc., to the created bitmap data as well.

A print section 37 comprises components necessary for forming an image using an imaging process such as an electrophotographic method or an electrostatic recording method; namely, a charging device, photoreceptor drum, exposure device, transfer roller, transfer belt, fixing device, and so on. To be more precise, the light according to the bitmap data is irradiated from the exposure device to the photoreceptor drum charged by the charging device to form an electrostatic latent image, to which charged toner is transferred to develop in a developing device, and the toner image is transferred to a paper medium through a first transfer roller and a second transfer roller and fixed by the fixing device.

[Security Management Device]

The security management device 40 comprises a controller 41, storage 42, communication section 43, display 44, operating section 45, and input device I/F section 46.

The controller 41 comprises a CPU and so on. The storage 42 comprises a memory such as a ROM and RAM, HDD, etc., and has a data storage 42a for storing print data, user authentication data, job status including a print document name, print status, number of sets, print time, and so on, and a program storage 42b for storing programs performing a print instruction function for instructing the image forming apparatus 30, a communication function to the image forming apparatus 30, a job status control function, a job status sending function for sending job statuses to the client 10, a job change receiving function for receiving job changes from the client 10, and so on. The programs stored in the ROM and HDD are opened or loaded in the RAM and executed by the CPU. In the present embodiment, the controller 41 also functions as a priority order determination section for controlling the interruption by confidential printing, by considering the submitted order of the print jobs. The priority order determination section may be configured as hardware or as a priority order determination program for making the computer to function as the priority order determination section; the program runs on the controller 41.

The communication section 43 comprises a NIC, modem, etc., and allows communication with the authentication server 20 and the image forming apparatus 30. The display 44 comprises an LCD and so on, to display a job list screen and a confidential printing unable-to-start notification screen which are to be described later. The operating section 45 comprises a keyboard, mouse, etc., and allows a variety of operations related to authentication and printing. The input device I/F section 46 functions as an interface to the user information input device 50.

[User Information Input Device]

The user information input device 50 comprises a reading section for reading user information from an IC card, etc., and a communication section for sending the read user information to the security management device 40. A medium for storing user information is not limited to an IC card; a magnetic card and RFID (Radio Frequency Identification) tag may also be used, or the reading section may be configured to read biological information such as finger prints and veins. Instead of the reading section, an input section may be provided to input a user ID and password.

FIG. 2 is only an example of the printing system in the present embodiment; its configuration may be appropriately changed as long as the control method of the present embodiment is achievable. For example, FIGS. 1 and 2 show the configurations for a case when the priority order of print jobs is determined in the security management device 40; however, as shown in FIG. 3, the priority order of print jobs may be determined in the image forming apparatus 30 allowing the image forming apparatus 30 to function as the security management device 40 also. Furthermore, as shown in FIG. 4, the user authentication data may be stored in the storage of the image forming apparatus 30 to perform user authentication in the image forming apparatus 30. Although the user information input device 50 is provided outside the security management device 40 (or the image forming apparatus 30) in FIGS. 1 to 4, the user information input device 50 may be incorporated inside the security management device 40 (or the image forming apparatus 30).

Next, the procedures for determining the priority order of print jobs in the priority order determination section of the security management device 40 as described above are explained with reference to the flowchart in FIG. 5.

When login is requested for a print job of confidential printing while another print job is currently executed, the controller 41 (priority order determination section) of the security management device 40 determines whether the current print job is confidential printing or not in Step S101, and if the current print job is confidential, the current print job is prioritized in Step S102. If the current print job is not confidential, whether the current print job has been submitted before the interrupting job or not is determined in Step S103; and if the current print job has been submitted first, the current print job is prioritized in Step S104. On the other hand, if the current print job has been submitted later, the interrupting job is prioritized in Step S105. In other words, only when the interrupting job is confidential printing, the current print job is normal printing, and the interrupting job has been submitted before the current print job, the interruption by the confidential printing is allowed.

The above control method is illustrated using the following example where print jobs—user A's normal printing (document 001.doc and document 002.doc), user B's confidential printing (document 003.doc and document 004.doc), user C's normal printing (document 005.doc), and user D's confidential printing (document 006.doc) are submitted in the respective order.

The job status control mechanism of the security management device 40 manages the above jobs, and the job status sending mechanism sends the job statuses to the client 10 periodically or upon request by a user. The job status receiving mechanism of the client 10 receives the job statuses from the security management device 40. FIG. 6 is an example of a job list screen displayed on the display 14 of the client 10. This job list screen lists information for each job including the user name who has submitted the job, whether it is confidential or normal printing, print document name, print status, date and time of the job submission, requested number of sets and pages for the print, number of printed copies and pages, elapsed time, estimated remaining time, and so on. Since the priority order of jobs are determined upon consideration of the submitted order in the present embodiment, the completion time of the jobs submitted in the system can be calculated. Min (completion time with no interruption by confidential printing) and Max (completion time when interrupted by confidential printing) are displayed as the estimated print completion time.

On this job list screen, the interruption rules for confidential printing based on FIG. 5 are as follows:

(1) User B's confidential print jobs (document names: document 003.doc and document 004.doc) cannot interrupt User A's normal print jobs (document names: document 001.doc and document 002.doc) during printing because the User B's print jobs were submitted after the User A's.

(2) User B's confidential print jobs (document names: document 003.doc and document 004.doc) can interrupt User C's normal print job (document name: document 005.doc) during printing because the User B's print jobs were submitted before the User C's.

(3) User D's confidential print job (document name: document 006.doc) cannot interrupt User C's normal print job (document name: document 005.doc) during printing because the User D's print job was submitted after the User C's.

In addition, each user can obtain the following information from the job list screen.

(1) User B can start his/her printing after User A's estimated print completion time (13:25:10). Since the printing time required for User B's confidential print job (document name: document 003.doc) is 00:42:40, its Min of the estimated print completion time is 14:07:50, which is 00:42:40 past 13:25:10. In addition, since the printing time required for User B's confidential print job (document name: document 004.doc) is 00:00:50, its Min of the estimated print completion time is 14:08:40, which is 00:00:50 past 14:07:50 or the estimated print completion time of the confidential print job (document name: document 003.doc).

(2) For User C, since the estimated print completion time for User A is 13:25:10 and the printing time required for User C's normal print job (document name: document 005.doc) is 00:16:40, its Min of the estimated print completion time when User B's output is canceled is 13:41:50, which is 00:16:40 past 13:25:10. Since the estimated print completion time for User B is 14:08:40 and the printing time required for User C's normal print job (document name: document 005.doc) is 00:16:40, its Max of the estimated print completion time when User B's output is executed is 14:25:20, which is 00:16:40 past 14:08:40.

(3) User D can start his/her printing after the completion of User C's printing. Since the Min of the estimated print completion time of User C's normal print job (document name: document 005.doc) is 13:41:50 and the printing time required for User D's confidential print job (document name: document 006.doc) is 00:01:25, User D's Min of the estimated print completion time is 13:43:15, which is 00:01:25 past 13:41:50. In addition, since the Max of the estimated print completion time of User C's normal print job (document name: document 005.doc) is 14:25:20 and the printing time required for User D's confidential print job (document name: document 006.doc) is 00:01:25, its Max of the estimated print completion time is 14:26:45, which is 00:01:25 past 14:25:20.

However, when two confidential print jobs are involved, the estimated print completion time may be changed. For example, if User B does not start his/her printing after the completion of User C's printing and User D starts his/her printing first, the estimated print completion time of User B's job will be changed.

A calculation method for the estimated remaining time and the estimated print completion time in FIG. 6 is not particularly limited; however, when constant numbers t_{A}, t_{B}, and t_{c} each representing time are given to the estimated print completion parameter of the following Chart 1 for example, the time required for printing T print time can be expressed in following Equation 1.

TABLE 1

| | Components affecting printing time | | |
|---|---|---|---|
| | CPU occupancy | Free memory | |
| | rate of image | space of image | |
| | forming | forming | Size of PDL |
| | apparatus | apparatus | (PCL/PS etc.) |
| Estimated | A | B | C |
| printing time | | | |
| parameter | | | |

Tₚᵣᵢₙₜₜᵢₘₑ=f(A, B, C)=t_{A}/A+t_{B}/B+t_{c}×C (1)

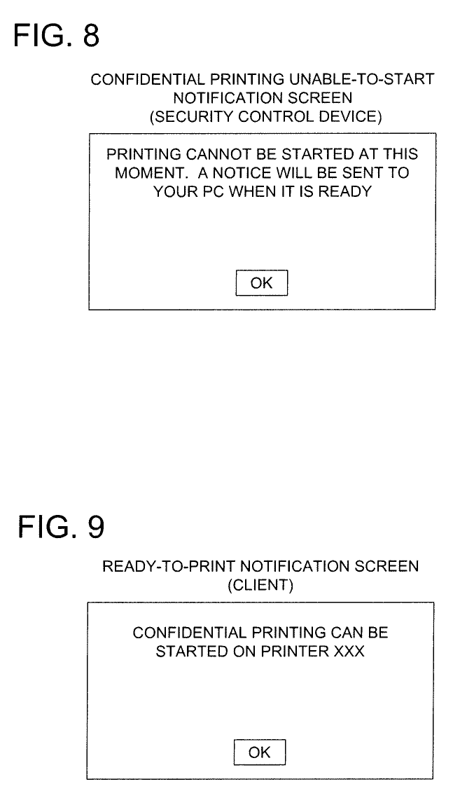

FIG. 7 is an example of a job list screen displayed on the display 44 of the security management device 40. This job list screen is the same as the job list screen displayed on the client 10 in FIG. 6; however, since this screen is used only by confidential printing users who have logged into the security management device 40, only jobs for the logged-in user are displayed in this example. The confidential printing user can start his/her confidential printing from this screen. In addition, in case the confidential printing user has to go away from the image forming device 30, this job list screen can be used to delete, abort, or resume jobs. When the confidential printing user's printing is aborted, the normal printing user's job is instantly resumed.

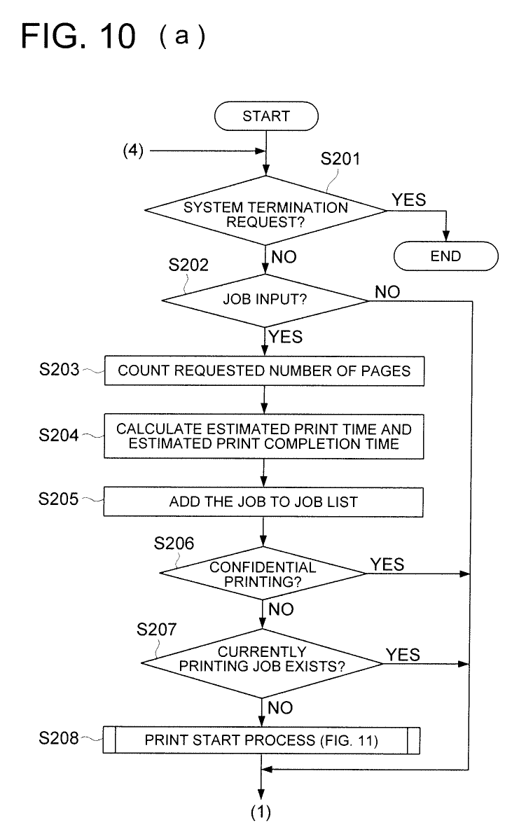

FIG. 8 is an example of a screen displayed on the display 44 when the confidential printing user logged into the security management device 40 is not yet allowed to start printing. For example, the screen is displayed when a confidential printing user—User B is logged into the security management device 40 during the normal printing of User A is running, provided that User B has no authority to interrupt User A's printing according to FIG. 5.

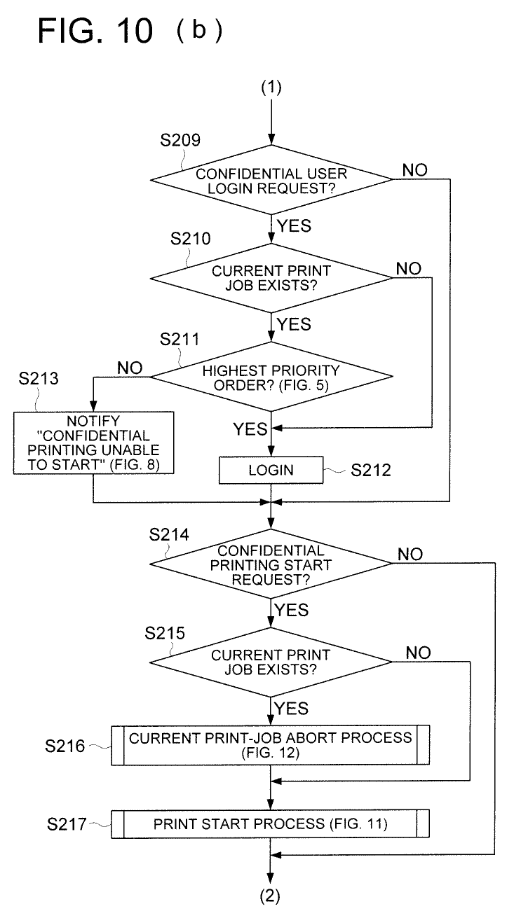

FIG. 9 is an example of a screen displayed on the display 14 of the client 10 to notify the user who has submitted the confidential print job that the job is ready to print. For example, after the normal printing of User A is completed according to FIG. 5, this screen is displayed on the display 14 of the client 10 of the confidential printing user—User B.

When a plurality of users have all submitted confidential print jobs, the priority is in the user who has started printing first. However, when confidential print jobs are submitted consecutively, the following way may be applied to start printing in the order of the job submission. For example, when User E has submitted a confidential print job first and User F has submitted his/her confidential print job consecutively, (1) this screen is displayed on the User E's client 10. (2) If User E starts printing within a certain time limit, this screen is displayed on the User F's client 10 after the completion or abort of the User E's printing. (3) If User E does not start printing within a certain time limit, this screen is displayed on the User F's client 10.

In this way, the unfairness to normal printing users can be redressed while prioritizing confidential print over normal printing not by simply allowing the confidential printing to interrupt but by prioritizing in consideration of the submission order of the print jobs such that when confidential printing interrupts (requests login) while there is a current print job, the printing job is prioritized if it is confidential printing, but if the printing job is normal printing, the order of the job submission is considered and if the printing job has been submitted first, the printing job (normal printing) is prioritized, but if the printing job has been submitted later, the interrupting job (confidential printing) is prioritized.

In addition, since the order of job processing becomes clear even when there is an interruption by confidential printing, and a print completion time for each job can be calculated based on the processing time, the convenience of users can be improved.

Some specific operations of the printing system using the priority order determination method of the present embodiment are described below with reference to the flowcharts in FIGS. 10 to 12. FIGS. 10(a) to 10(d) show a series of operations divided into separate figures for drawing convenience. The following flows are executed in the controller 41 of the security management device 40.

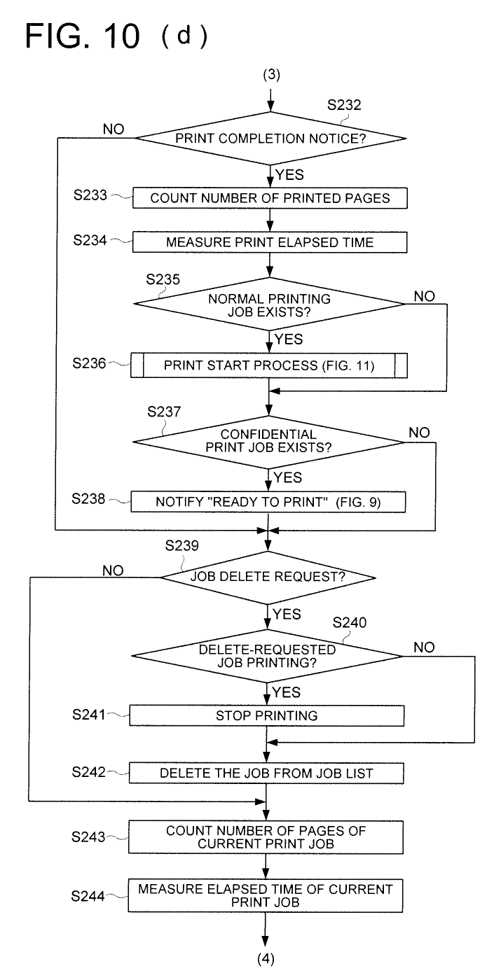

First, as shown in FIG. 10(a), whether a system termination is requested or not is determined (S201), and if there is such a request, the process is terminated. If no termination request is found, whether a print job is submitted or not is determined (S202), and if no submission is found, the process skips to Step S209. If a print job is submitted, the requested number of pages for the print is counted (S203), the estimated print time required and the estimated print completion time are calculated (S204), and the job is added to the job list (S205). Then whether the submitted job is confidential printing or not is determined (S206), and if it is confidential printing, the process skips to Step S209. If it is not confidential, whether there is a current print job or not is determined (S207), and if there is a printing job, the process skips to Step S209. If no job is currently printing, a print start process according to the flow in FIG. 11 is performed for the submitted print job (S208).

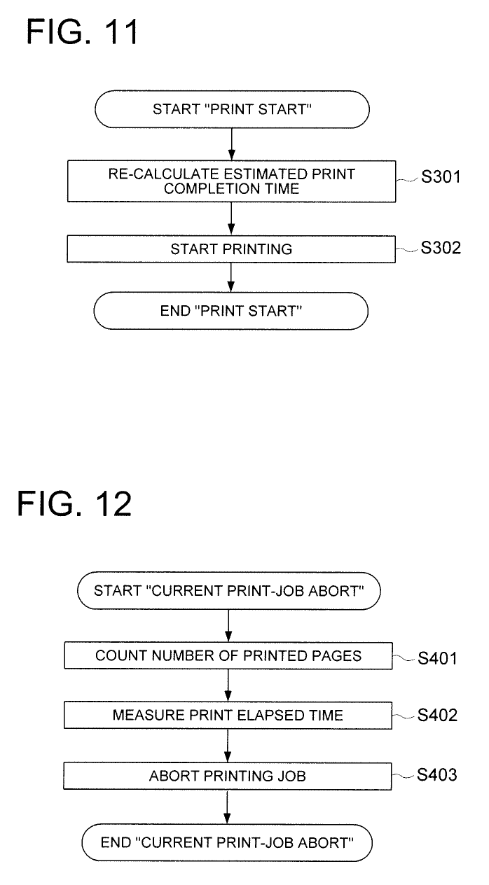

Next, as shown in FIG. 10(b), whether the confidential printing user has requested to login at the security management device 40 or not is determined (S209), and if no login request is found, the process skips to Step S214. If the login request is found, whether there is a current print job or not is determined (S210), and if no job is currently printing, the process skips to Step S212. If there is a current print job, the priority order determination section determines the priority order based on the flow in FIG. 5 (S211). Then, if the priority order of the job of the user who has requested to login is the highest, the login is allowed (S212), or else, the confidential printing unable-to-start screen in FIG. 8 is displayed (S213). Next, whether the confidential printing user already logged in has requested to start the confidential printing or not is determined (S214), and if no start request is found, the process skips to Step S218. If the start request is found, whether there is a current print job or not is determined (S215), and if no job is currently printing, the print start process according to the flow in FIG. 11 is performed for the confidential print job (S217). If there is a current print job, after a current print-job abort process according to the flow in FIG. 12 is performed (S216), the print start process according to the flow in FIG. 11 is performed for the confidential print job (S217).

Next, as shown in FIG. 10(c), whether an abort is requested for the confidential print job or not is determined (S218), and if no abort request is found, the process skips to S222, but if the abort request is found, the current print-job abort process according to the flow in FIG. 12 is performed (S219). Next, whether a normal print job is in the job list or not is determined (S220), and if no normal print job is found, the process skips to Step S222, but if the normal print job is found, the print start process according to the flow in FIG. 11 is performed for the normal print job (S221).

Next, whether a restart is requested for the confidential print job or not is determined (S222), and if no resuming request is found, the process skips to Step S226. If the resuming request is found, whether there is a current print job or not is determined (S223), and if no job is currently printing, the print start process is performed according to the flow in FIG. 11 for the confidential print job (S225). If there is a current print job, after the current print-job abort process according to the flow in FIG. 12 is performed (S224), the print start process according to the flow in FIG. 11 is performed for the confidential print job (S225).

Next, whether the confidential print user has requested to logout at the security management device 40 or not is determined (S226), and if no logout request is found, the process skips to Step S232. If the logout request is found, whether the requested user's job is currently printing or not is determined (S227), and if it is not currently printing, the logout is performed (S231). If it is currently printing, the current print-job abort process according to the flow in FIG. 12 is performed (S228), then whether there is a normal print job or not is determined (S229), and if no normal print job is found, the logout is performed (S231). If there is a normal print job, the print start process according to the flow in FIG. 11 is performed for the normal print job (S230), then the logout is performed (S231).

Next, as shown in FIG. 10(d), whether the print completion is notified or not is determined (S232), and if it is not notified, the process skips to Step S239. If the print completion is notified, the number of printed pages of the completed job is counted (S233) and the print elapsed time is measured (S234). At this time, whether there is a normal print job in the job list or not is determined (S235), and if no normal print job is found, the process skips to S237. If there are normal print jobs, the printing of the job having the earliest submission time in the normal print jobs is started or resumed according to the flow in FIG. 11 (S236). Next, whether or not there is a confidential print job submitted earlier than any normal print job in the job list is determined (S237), and if no such confidential print job is found, the process skips to Step S239. If there is such a confidential print job, the ready-to-print notification screen in FIG. 9 is displayed on the client 10 (S238).

Next, whether a job deletion is requested or not is determined (S239), and if no delete request is found, the process skips to Step S243. If there is a delete request, whether the job to be deleted is current print or not is determined (S240) and if it is current print, the printing is stopped (S241) and the job is deleted from the job list (S242). Next, the number of printed pages of the current print job is counted (S243) and the elapsed time is measured (S244). After that, the process returns to Step S201 and repeats the same procedures.

FIG. 11 shows a flow example of the print start process used in FIG. 10. To start printing, the estimated print completion time is re-calculated (S301), then printing is started (S302).

FIG. 12 shows a flow example of the current print-job abort process used in FIG. 10. To abort printing, the number of printed pages is counted (S401), the print elapsed time is measured (S402), and then, the current print job is aborted (S403).

Note that the flows in FIGS. 10 to 12 are only examples, and the order or detail of the processes may be appropriately changed as long as the printing is performed based on the priority order of print jobs determined according to the flow in FIG. 5.

What is claimed is:

1. A priority order determination method for print jobs in a printing system which can execute normal print jobs by submitting the print jobs and confidential print jobs by logging-in after submission of the confidential print job, the method comprising:
prioritizing a second print job relating to confidential print over a first print job relating to normal print job, in a case when login for the second print job is requested during printing of the first print job and the second print job has been submitted before the first print job.

2. The priority order determination method of claim 1, further comprising notifying that the second job can not be started when the first print job has been submitted before the second print job.

3. The priority order determination method of claim 2, further comprising notifying that the second print job is ready to start when the first print job has completed.

4. The priority order determination method of claim 1, further comprising calculating each completion time of a plurality of print jobs submitted in the system in a case where the plurality of print jobs are prioritized and notifying the calculated completion time.

5. A computer-readable storage medium storing computer program executable in a system which can execute normal print jobs by submitting the print jobs and confidential print jobs by logging-in after submission of the confidential print job, by a computer to make the computer function as a priority order determination section,
wherein the determination section prioritizes a second print job relating to confidential print over a first print job relating to normal print job, in a case when login for the second print job is requested during printing of the first print job and the second print job has been submitted before the first print job.

6. The computer-readable storage medium of claim 5, wherein the determination section notifies that the second job can not be started when the first print job has been submitted before the second print job.

7. The computer-readable storage medium of claim 6, wherein when the first print job has completed the determination section notifies that the second print job is ready to start.

8. The computer-readable storage medium of claim 5, wherein the determination section calculates each completion time of a plurality of print jobs submitted in the system in a case where the plurality of print jobs are prioritized and notifies the calculated completion time.

9. A printing system comprising:
a plurality of client devices each of the plurality of client devices configured to send a print job;
a management device configured to control the print job; and
an image forming apparatus configured to execute printing according to the print job;
wherein the printing system can execute normal print job by submitting a print job and confidential print job by logging-in after submission of a confidential print job; and
wherein the management device is configured to prioritize a second print job relating to confidential printing over a first print job relating to normal printing job, in a case when login for the second print job is requested during printing of the first print job and the second print job has been submitted before the first print job.

10. The printing system of claim 9, wherein the management device is configured to notify that the second job can not be started when the first print job has been submitted before the second print job.

11. The printing system of claim 10, wherein the management device is configured to notify that the second print job is ready to start when the first print job has completed.

12. The printing system of claim 9, wherein the management device is configured to calculate each completion time of a plurality of print jobs submitted in the system in a case where the plurality of print jobs are prioritized, and configured to display the calculated completion time as a list screen.

13. The printing system of claim 9, wherein the management device is configured to calculate each completion time of a plurality of print jobs submitted in the system in a case where the plurality of print jobs are prioritized, and configured to notify the calculated completion time to the client device, and wherein the client device is configured to display the calculated completion time as a list screen.

14. The printing system of claim 9, wherein the management device is provided in the image forming apparatus.
